(19) United States
(12) Patent Application Publication
(10) Pub. No.: US 2018/0217875 A1
(43) Pub. Date: Aug. 2, 2018

(54) DATA PROCESSING SYSTEM AND DATA PROCESSING METHOD

(71) Applicant: Hitachi, Ltd., Tokyo (JP)

(72) Inventors: Tadashi TAKEUCHI, Tokyo (JP); Hideo AOKI, Tokyo (JP); Tsuyoshi TANAKA, Tokyo (JP); Yuuya ISODA, Tokyo (JP)

(21) Appl. No.: 15/747,785

(22) PCT Filed: Feb. 17, 2016
(86) PCT No.: PCT/JP2016/054495

§ 371 Date: Jan. 26, 2018

(51) Int. Cl. G06F 9/50; G06F 9/48

(52) U.S. Cl. CPC G06F 9/5088; G06F 2209/501; G06F 9/4856

(57) ABSTRACT

A data processing system in which application nodes capable of executing a program are provided at sites at a plurality of locations, and storage nodes for storing data are also provided at the plurality of locations, with these locations being coupled to one another via a network, wherein: a first application node stores a program I/O history; a second application node reproduces I/O events on the basis of the I/O history, thereby estimating data processing performance; and the first application node determines, on the basis of the data processing performance estimation, whether or not to transfer the program to the second application node.

### TECHNICAL FIELD

The present invention relates to a distributed data processing apparatus and a method and, particularly, to an apparatus and a method for executing, at high speed, a computing process with respect to data distributed and arranged over a wide area while suppressing network communication cost.

### BACKGROUND ART

Techniques described in PTL 1 and PTL 2 are known as an apparatus and a method for executing, at high speed, a computing process with respect to data distributed and arranged over a wide area. With the technique described in PTL 1, a technique for transferring an application from a specific device to a remotely located device and continuing execution is provided. Using this technique, by migrating an application for performing a computing process on data distributed and arranged over a wide area to a device in a vicinity of the data, access latency when accessing the data can be reduced.

Meanwhile, with the technique described in PTL 2, a technique is provided which collectively manages statistical information on network band usage and information on requests related to network performance and, when the network band usage (attained performance) falls below the request information, migrates a target VM (program) to a host capable of using a larger free network band. Using this technique enables a network band upon data access to be maximized.

### CITATION LIST

### Patent Literature

[PTL 1]
Cisco, “Application Context Transfer for Distributed Computing Resources”, Patent US2013/0212212, August 2013.
[PTL 2]
Microsoft, “Controlling Network Utilization”, US2013/0007254, June 2011.

### SUMMARY OF INVENTION

### Technical Problem

The techniques described in Background Art enable latency of data access which is created during a computing process with respect to data distributed and arranged over a wide area or a network band to be maximized.

However, it is difficult to maximize program-level data processing throughput (effective performance) by simply combining these techniques. One of the reasons for this difficulty is that there is no guarantee that both data access latency and a network band can be optimized at the same time. In other words, situations may arise where reducing latency prevents a network band from being obtained or raising a network band causes latency to increase. In addition, which of the data access latency and the network band needs to be intensively optimized may vary depending on programs. For example, while an importance of optimization of access latency decreases with a program which produces sufficient I/O parallelism, when I/O parallelism is insufficient, access latency must be intensively optimized.

An object of the present invention is to increase performance of a computing process with respect to data arranged in a distributed manner while also taking program characteristics into consideration.

### Solution to Problem

The present invention provides application nodes capable of executing a program at sites at a plurality of locations and also provides storage nodes storing data at the plurality of locations, the locations being coupled to one another via a network, wherein a first application node that is an application node among the plurality of application nodes is configured to:

store a history of I/O events issued to a storage node by executing the program;
measure actual data processing performance during execution of the program;
accept a list of the application nodes that can be transfer destination candidates of the program; and
make a history reproduction request of I/O events, which include the history of I/O events, to a second application node included in the list of the application nodes,
a second application node having received the history reproduction request of I/O events is configured to:
issue reproduction I/O events for reproducing the I/O events issued by the program in accordance with the history of I/O events included in the history reproduction request of I/O events and obtain performance of the reproduction I/O events as estimated performance of I/O events, and
the first application node is configured to:
determine, on the basis of the estimated performance of I/O events obtained by the second application node, whether or not to transfer the program to the second application node.

### Advantageous Effects of Invention

According to the present invention, performance of a computing process with respect to data arranged in a distributed manner can be increased while also taking program characteristics into consideration.

### BRIEF DESCRIPTION OF DRAWINGS

FIG. 1 is a diagram showing a software module configuration of a first embodiment of the present invention.

FIG. 2 is a diagram showing a hardware configuration of an application node.

FIG. 3 is a diagram showing a hardware configuration of a storage node.

FIG. 4 is a diagram showing an overall processing flow of the first embodiment of the present invention.

FIG. 5 is a diagram showing a user interface of a data transfer destination determination unit.

FIG. 6 is a diagram showing a data structure of a transfer policy.

FIG. 7 is a diagram showing a data structure of an I/O history.

FIG. 8 is a diagram showing a data structure of actual processing performance.

FIG. 9 is a diagram showing a data structure of estimated processing performance.

FIG. 10 is a diagram showing an operation flow of an I/O history recording unit and a flow for acquiring a CPU utilization rate.

FIG. 11 is a diagram showing an operation flow of a transfer destination determination unit.

FIG. 12 is a diagram showing an operation flow of a data processing performance estimation unit.

FIG. 13 is a diagram showing a module configuration and a summary of operations of a storage control unit.

FIG. 14 is a diagram showing a software module configuration of a second embodiment of the present invention.

FIG. 15 is a diagram showing a user interface of a measurement accuracy optimization unit.

FIG. 16 is a diagram showing a data structure of a measurement policy.

FIG. 17 is a diagram showing a data structure of a measurement load.

FIG. 18 is a diagram showing a data structure of a measurement parameter.

FIG. 19 is a diagram showing an operation flow of a measurement accuracy optimization unit.

### DESCRIPTION OF EMBODIMENTS

### First Embodiment

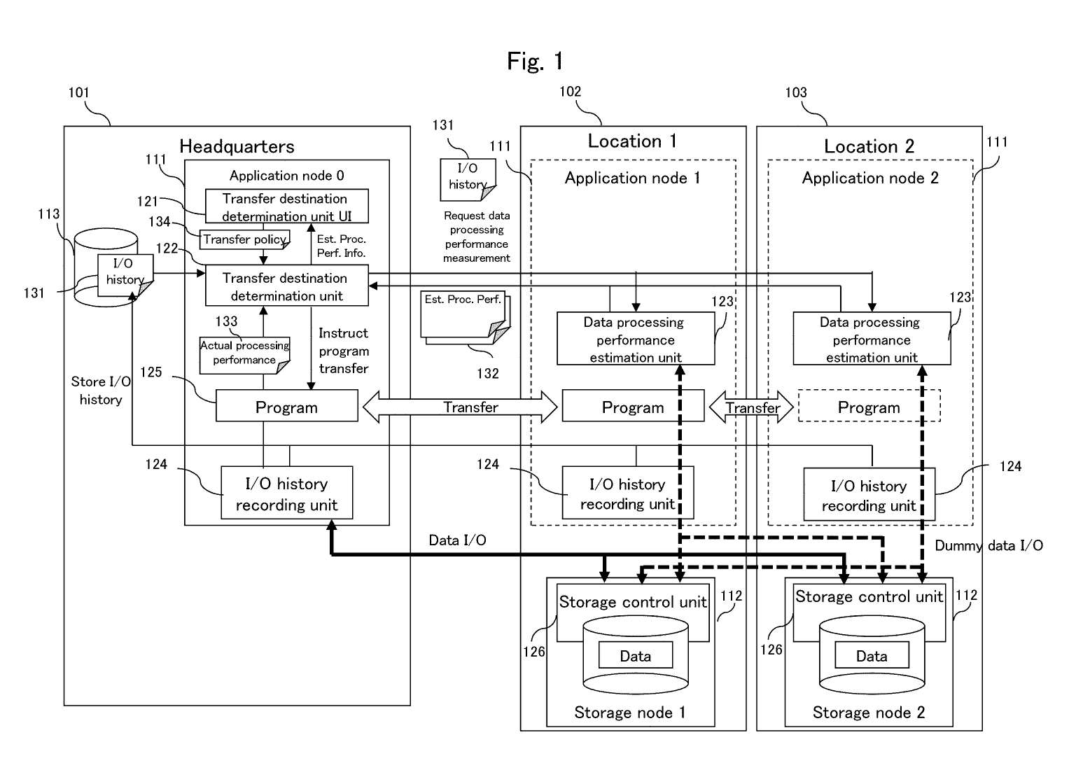

FIG. 1 shows a software module configuration of a first embodiment of the present invention.

The first embodiment of the present embodiment assumes that computers arranged at a headquarters site (101) and location sites (102 and 103) cooperate with each other to perform a data computing process.

An application node or an application VM (111) (hereinafter, abbreviated as an “application node”) is arranged at the headquarters site and the location sites, and a program (125) runs on the node to execute a computing process. In addition, a storage node or a storage VM (112) (hereinafter, abbreviated as a “storage node”) is arranged at at least the location sites to store data to be a target of the computing process. The application node or the storage node corresponds to one computer or one virtual computer. While a storage node realizes labor-saving at the headquarters in FIG. 1, alternatively, the headquarters may be provided with a storage node 0.

The program (125) has a function for being transferred to an application node (111) which optimizes data processing throughput and for continuing processing. In order to determine the optimal transfer destination, first, an I/O history recording unit (124) runs on each application node (111). The I/O history recording unit (124) has a function for recording an I/O history (131) issued to a storage node when a CPU executes the program in a storage medium (113) coupled to the application node (111) arranged at the headquarters site (101). In addition, actual processing performance (133) which stores data processing throughput performance upon execution of the program can also be measured.

Furthermore, a transfer destination determination unit user interface (121) and a transfer destination determination unit (122) run on the application node (111) arranged at the headquarters site (101), and a data processing performance estimation unit (123) runs on the application node (111) arranged at at least the location sites (102 and 103).

The transfer destination determination unit user interface (121) receives a transfer policy (134) including information on a list of application nodes to be transfer destination candidates of the program (125) from a user and hands over the transfer policy (134) to the transfer destination determination unit (122). The transfer destination determination unit (122) issues a data processing performance measurement request including the I/O history (131) recorded by the I/O history recording unit (124) to the data processing performance estimation unit (123) running on the application node (111) described in the present policy.

The data processing estimation unit (123) having received the request reproduces I/O events on the basis of the I/O history (131) included in the request. In addition, a data processing throughput that is obtained when the program (125) is transferred to the application node (111) is estimated, and an estimated processing performance (132) thereof is transmitted to the transfer destination determination unit.

The transfer destination determination unit (122) determines the application node (111) to be an optimal transfer destination of the program on the basis of the actual processing performance (133) measured by the I/O history recording unit (124) and the estimated processing performance (132) received from the data processing performance estimation unit (123). In addition, an instruction for transferring the program to the application node (111) is issued to the program (125).

Upon receiving the instruction, the program (125) causes the transfer to the specified application node (111) to be executed and subsequently continues processing.

Moreover, the storage node (112) is mounted with a storage control unit (126). The storage control unit (126) has a function of processing not only data I/O events issued by the program (125) but also dummy data I/O events issued by the data processing estimation unit (123). While I/O events with respect to a storage medium of the storage node are executed in data I/O processing, in dummy data I/O processing, a lapse of I/O processing time is emulated without performing the I/O events. According to the present function, generation of a load on the storage medium during a measurement of estimated processing performance by the data processing performance estimation unit (123) can be suppressed.

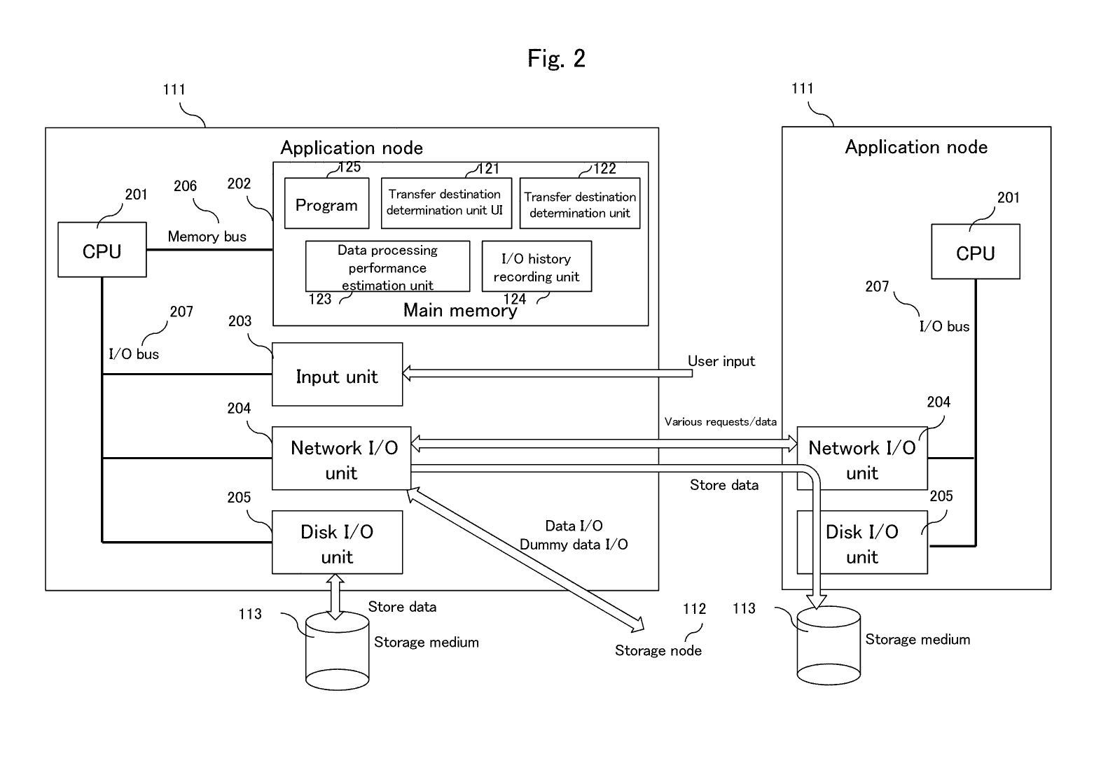

FIG. 2 shows a hardware configuration of the application node (111) according to an embodiment of the present invention.

The application node (111) includes a CPU (201), a main memory (202), an input unit (203), a network I/O unit (204), and a disk I/O unit (205). The main memory (202) stores application execution codes including the program (125), the transfer destination determination unit user interface (121), the transfer destination determination unit (122), the data processing performance estimation unit (123), and the I/O history recording unit (124). The CPU (201) loads these codes to perform application execution. In addition, data I/O events can be performed with respect to the coupled storage medium (113) via the disk I/O unit (205). Furthermore, the application node (111) can communicate with the storage node (112) to perform data I/O events and dummy data I/O events.

When necessary, input from a user such as input of the transfer policy (134) can be acquired via the input unit (203). In addition, requests such as a data processing performance measurement request and data such as the I/O history (131) and the estimated processing performance (132) can be transmitted to and received from other application nodes (111) via the network I/O unit (204). Furthermore, data such as the I/O history (131) can be stored, via the network I/O unit (204), in the storage medium (113) coupled to other application nodes (111).

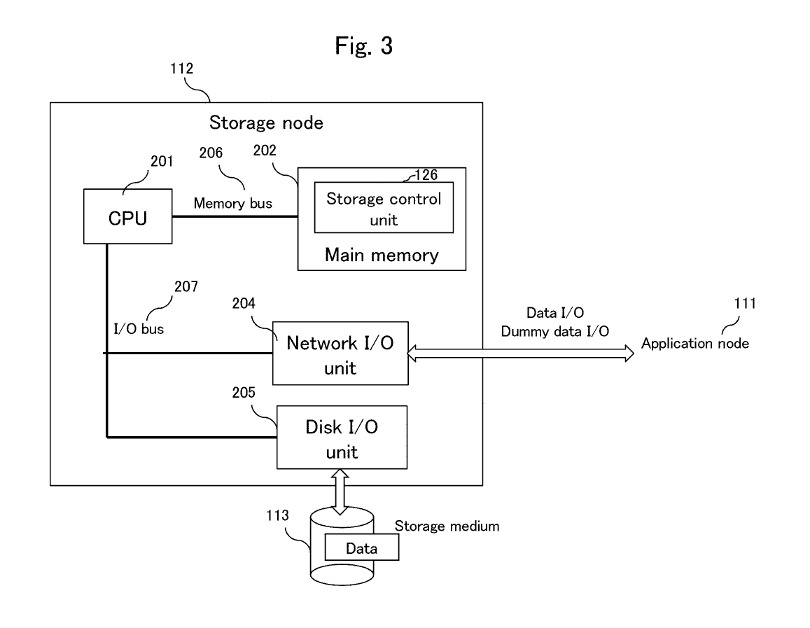

FIG. 3 shows a hardware configuration of the storage node (112) according to an embodiment of the present invention.

The storage node (112) also includes a CPU (201), a main memory (202), a network I/O unit (204), and a disk I/O unit (205) in a similar manner to the application node (111).

The main memory (202) is mounted with an application execution code including the storage control unit (126), and the CPU (201) loads the execution code to perform application execution.

A data I/O request or a dummy data I/O request is received from the application node (111) via the network I/O unit (204), and the request is processed at the storage control unit (126).

In addition, disk I/O events with respect to the coupled storage medium (113) can also be executed via the disk I/O unit (205).

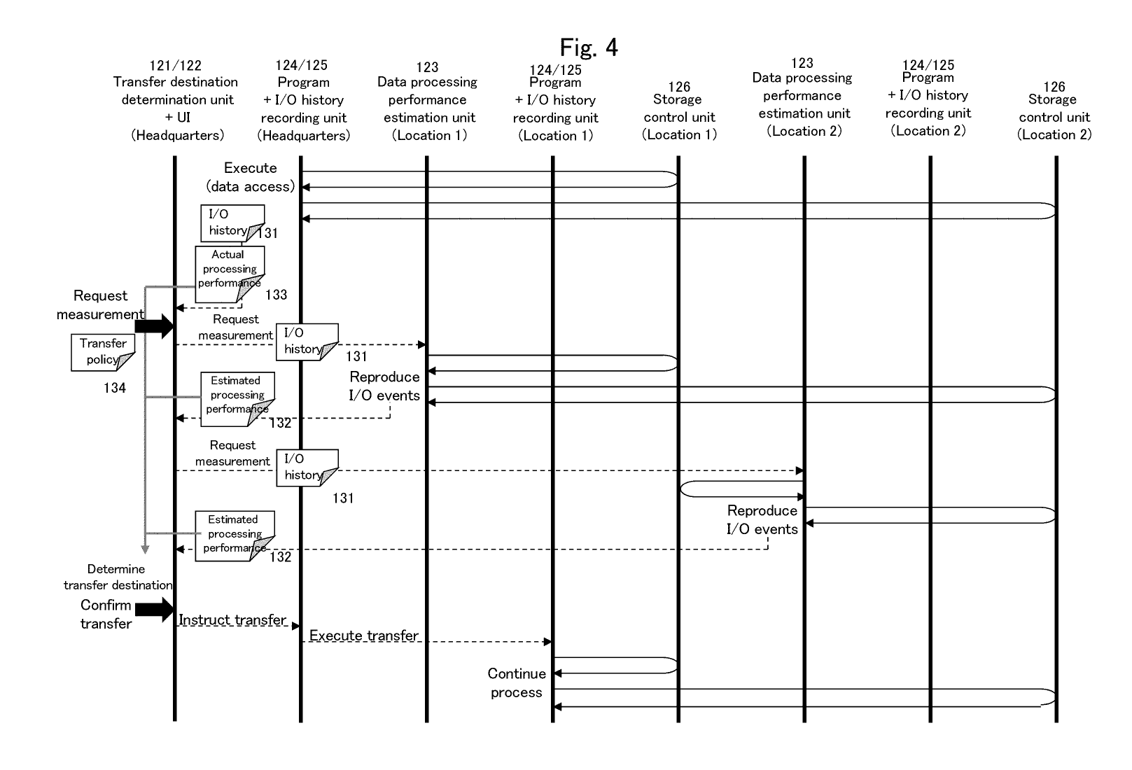

FIG. 4 shows an overall processing flow of an embodiment of the present invention.

First, in an initial state of the present embodiment, the program (125) and the I/O history recording unit (124) are running on the application node (111) arranged at the headquarters site (101). Subsequently, the program performs a computing process while acquiring data from the storage control unit (126) on the storage node (112) arranged at the location sites (102 and 103). In this case, the I/O history recording unit acquires the I/O history (131) and the actual processing performance (133), and hands over the I/O history (131) and the actual processing performance (133) to the transfer destination determination unit (122).

The transfer destination determination unit (122) acquires the transfer policy (134) from the user via the transfer destination determination unit user interface (121), and issues a data processing performance measurement request with respect to the data processing performance estimation unit (123) existing on the application node (111) described in the transfer policy (134). This request also includes the I/O history (131) acquired by the I/O history recording unit (124).

The data processing performance estimation unit (123) having received the present request issues a dummy data I/O request with respect to the storage control unit (126) and executes reproduction of events in the I/O history. In addition, the data processing performance estimation unit (123) calculates the estimated processing performance (132) and transmits the estimated processing performance (132) to the transfer destination determination unit (122).

The transfer destination determination unit (122) determines an optimal transfer destination of the program (125) on the basis of the actual processing performance (133) and the estimated processing performance (132), and issues an instruction for transfer to the application node (111) to be the transfer destination with respect to the program (125). The program (125) executes the transfer to the application node (111) and subsequently continues processing.

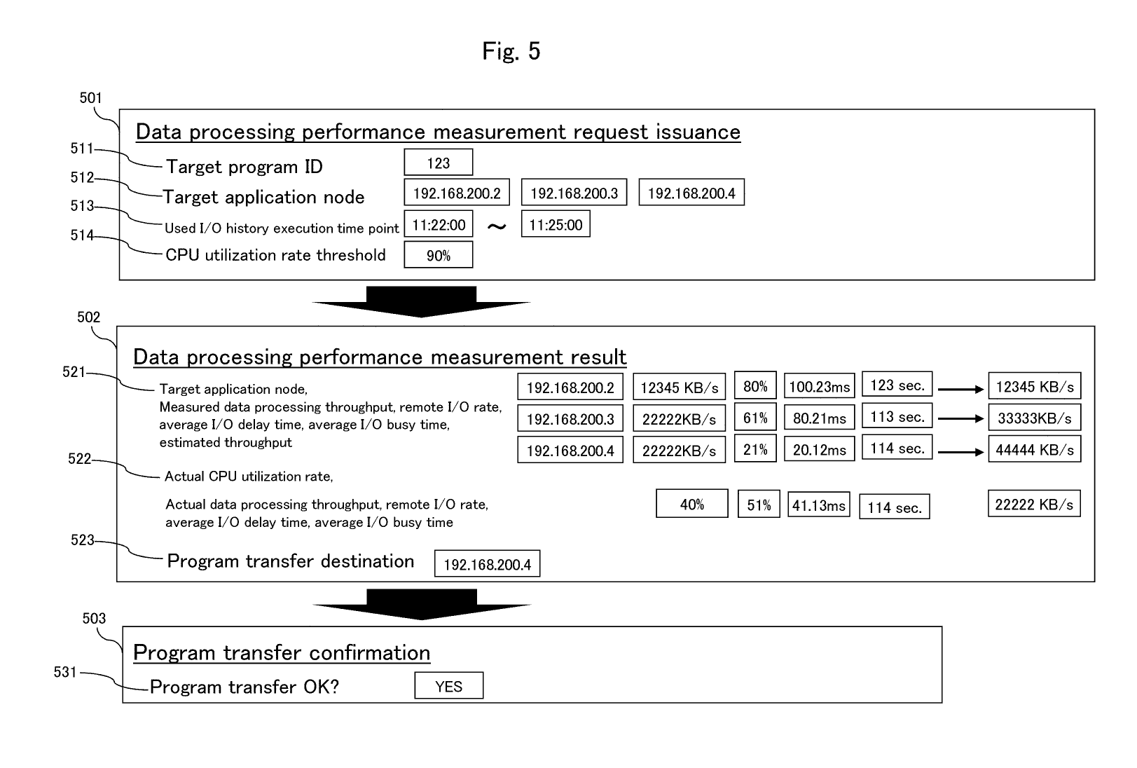

FIG. 5 shows a user interface screen provided by the data processing performance measurement unit user interface (121).

The present user interface screen is constituted by a data processing performance measurement request issuance acceptance screen (501) from the user, a data processing performance measurement result display screen (502), and a program transfer confirmation screen (503).

The data processing performance measurement request issuance acceptance screen (501) is constituted by regions of a “target program ID” (511), a “target application node” (512), a “used I/O history execution time point” (513), and a “CPU utilization rate threshold” (514). Each region is specified by the user. An ID of the program (125) to be a transfer target is specified in the “target program ID”. An IP address of the application node (111) to be a transfer destination candidate is specified in the “target application node”. A time point range of the I/O history (131) to be attached to a data processing performance measurement request issued by the transfer destination determination unit (122) with respect to the data processing performance estimation unit (123) is specified in the “used I/O history execution time point”. A threshold to be used by the transfer destination determination unit (122) for determining whether or not the program (125) to be the target is running in a CPU bottleneck state is specified in the “CPU utilization rate threshold”.

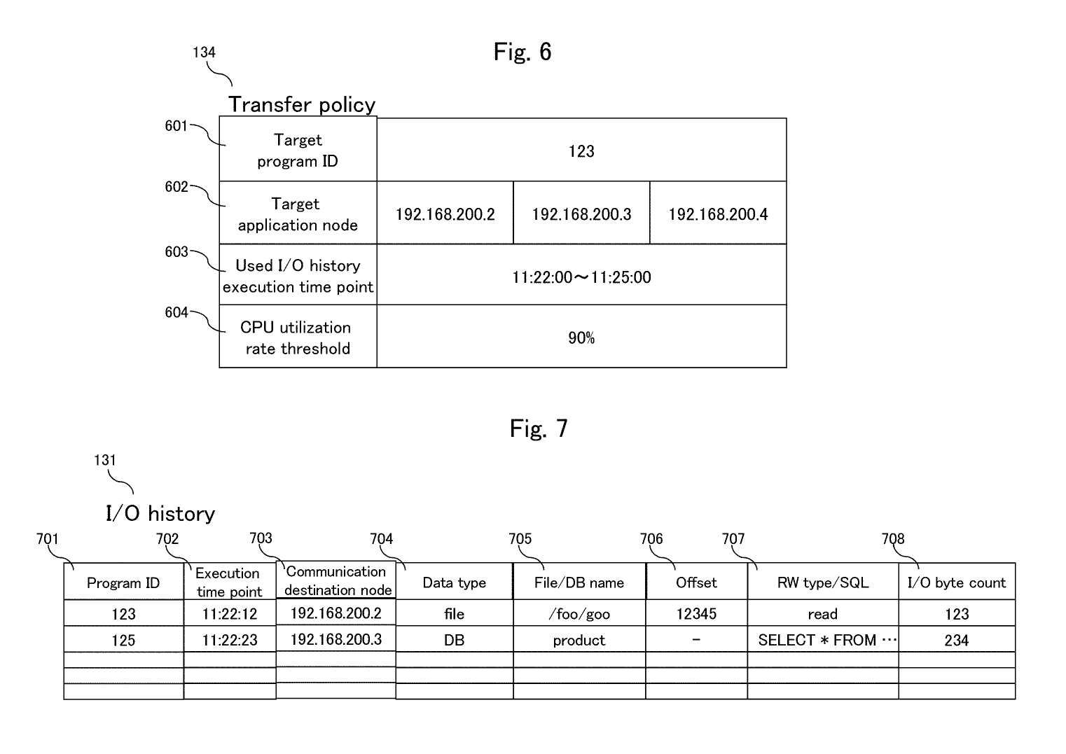

The transfer policy (134) having a data structure shown in FIG. 6 is generated on the basis of information specified on the present screen. The transfer policy includes fields of a “target program ID” (601), a “target application node” (602), a “used I/O history execution time point” (603), and a “CPU utilization rate threshold” (604), and values specified on the data processing performance measurement request issuance acceptance screen (501) described above are stored in the respective fields.

The data processing performance measurement result display screen (502) is constituted by regions of “measured data processing throughput, remote I/O rate, average I/O delay time, average I/O busy time, and estimated throughput” (521), “actual CPU utilization rate, actual data processing throughput, remote I/O rate, average I/O delay time, and average I/O busy time” (522), and a “program transfer destination” (523). After input by the user on the data processing performance measurement request issuance acceptance screen (501), results are displayed in the respective regions of the data processing performance measurement result display screen (502).

As a result of input on the data processing performance measurement request issuance acceptance screen, the transfer destination determination unit (122) issues a data processing performance measurement request with respect to the data processing performance estimation unit (123). Subsequently, the transfer destination determination unit (122) receives the estimated processing performance (132) from the data processing performance estimation unit (123). Information in the received estimated processing performance (132) is displayed in “measured data processing throughput, remote I/O rate, average I/O delay time, and estimated throughput”.

As shown in FIG. 9, the estimated processing performance (132) has fields of a “program ID” (901), an “I/O history execution time point” (902), a “cumulative I/O byte count” (903), a “cumulative remote I/O byte count” (904), a “cumulative I/O delay time” (905), a “cumulative I/O busy time” (906), and an “estimated throughput” (907). A program ID to be a measurement target is stored in the “program ID” (901). Time point information of the I/O history (131) reproduced by the data processing performance estimation unit (123) is stored in the “I/O history execution time point” (902). A cumulative I/O byte count of dummy data I/O requests issued when reproducing the I/O history at the time point described above is stored in the “cumulative I/O byte count” (903). A total of the byte count of dummy data I/O events issued with respect to the storage node (112) arranged at a different location among the total I/O byte count described above is stored in the “cumulative remote I/O byte count” (904). A total I/O response time in dummy data I/O request processes issued when reproducing the I/O history (131) at the time point described above is stored in the “cumulative I/O delay time” (905). A cumulative value of time during which any dummy I/O event had been executed (an I/O event exists for which an I/O request had been issued but an I/O completion notification has not been received) is stored in the “cumulative I/O busy time” (906). Data processing throughput estimated by the data processing performance estimation unit (122) on the basis of these measurement results is stored in the “estimated throughput” (907).

The migration destination determination unit (122) calculates, from the estimated processing performance (132) having the fields described above, an average of data processing throughput (the “cumulative I/O byte count” (903)), an average of “cumulative remote I/O byte count” (904)/““cumulative I/O byte count” (903), an average of the “cumulative I/O delay time” (905), an average of the “cumulative I/O busy time” (906), and an average of the “estimated throughput” (907), and hands over the calculated averages to the migration destination determination unit user interface (121). Subsequently, the migration destination determination unit user interface (121) causes the information to be displayed in the region of “measured data processing throughput, remote I/O rate, average I/O delay time, average I/O busy time, and estimated throughput” (521) of the data processing performance measurement result display screen.

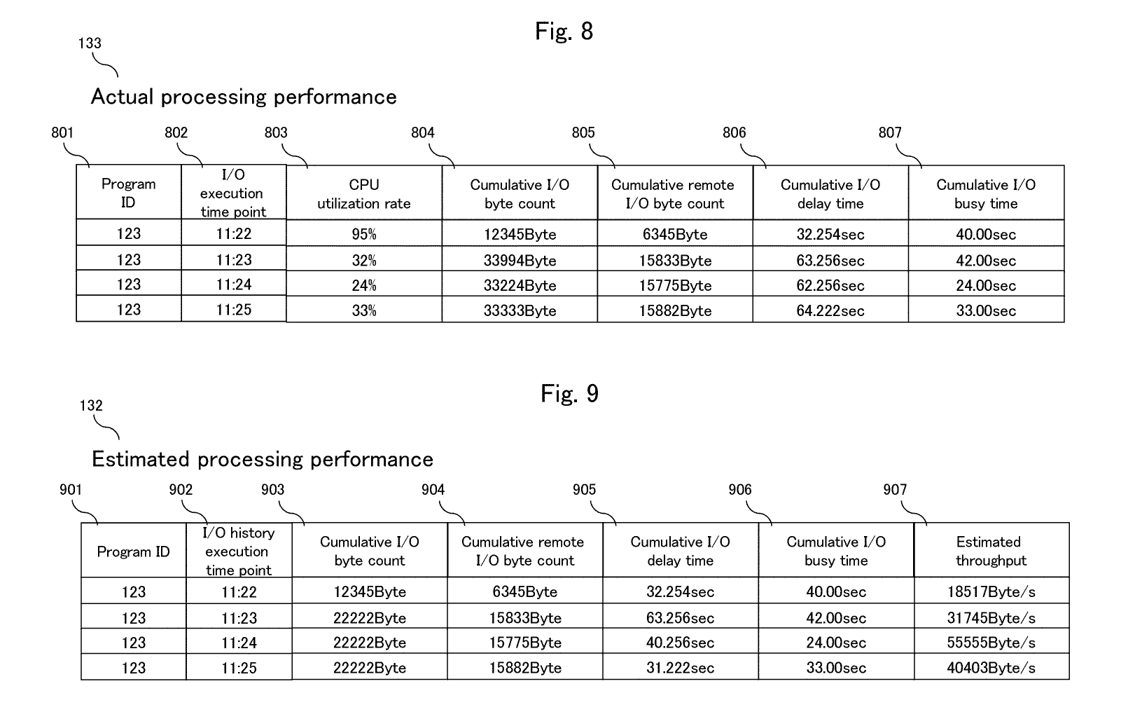

In addition, the migration destination determination unit (122) receives the actual processing performance (133) from the I/O history recording unit (124). Information on the actual processing performance is displayed in “actual CPU utilization rate, actual data processing throughput, remote I/O rate, average I/O delay time, and average I/O busy time” (522). As shown in FIG. 8, the actual processing performance (133) has fields of a “program ID” (801), an “I/O execution time point” (802), a “CPU utilization rate” (803), a “cumulative I/O byte count” (804), a “cumulative remote I/O byte count” (805), a “cumulative I/O delay time” (806), and a “cumulative I/O busy time” (807). An ID of the program (125) to be a measurement target is stored in the “program ID” (801). A time point at which the program (125) had issued a data I/O request is stored in the “I/O execution time point” (802). A CPU utilization rate at the time point is stored in the “CPU utilization rate” (803). A total of an I/O byte count of the data I/O request issued at the time point is stored in the “cumulative I/O byte count” (804). A total of the byte count of data I/O events issued with respect to the storage node (112) arranged at a different location among the total I/O byte count described above is stored in the “cumulative remote I/O byte count” (805). A total I/O response time in data I/O request processes issued when reproducing the I/O history at the time point described above is stored in the “cumulative I/O delay time” (806). A cumulative value of time during which any I/O event had been executed (an I/O event exists for which an I/O request had been issued but an I/O completion notification has not been received) is stored in the “cumulative I/O busy time” (807).

The migration destination determination unit (122) calculates, from these pieces of information, an average of the “CPU utilization rate” (803), an average of data processing throughput (the “cumulative I/O byte count” (804)), an average of “cumulative remote I/O byte count” (805)/“cumulative I/O byte count” (804), an average of the “cumulative I/O delay time” (806), and an average of the “cumulative I/O busy time” (807), and hands over the calculated averages to the migration destination determination unit user interface (121). Subsequently, the migration destination determination unit user interface (121) causes the information to be displayed in the region of “actual CPU utilization rate, actual data processing throughput, remote I/O rate, average I/O delay time, and average I/O busy time” (522) of the data processing performance measurement result display screen (502).

An IP address of the application node (111) determined to be optimal as the transfer destination of the program (125) as a result of measurement of the data processing performance is displayed in the “program transfer destination” (523).

The data transfer confirmation screen (503) is constituted by a region of “program transfer confirmation” (531). When desiring to execute the transfer displayed on the data processing performance measurement result screen (502), the transfer destination determination unit (122) starts issuance of a transfer instruction with respect to the program (125) as the user inputs an instruction to execute the transfer.

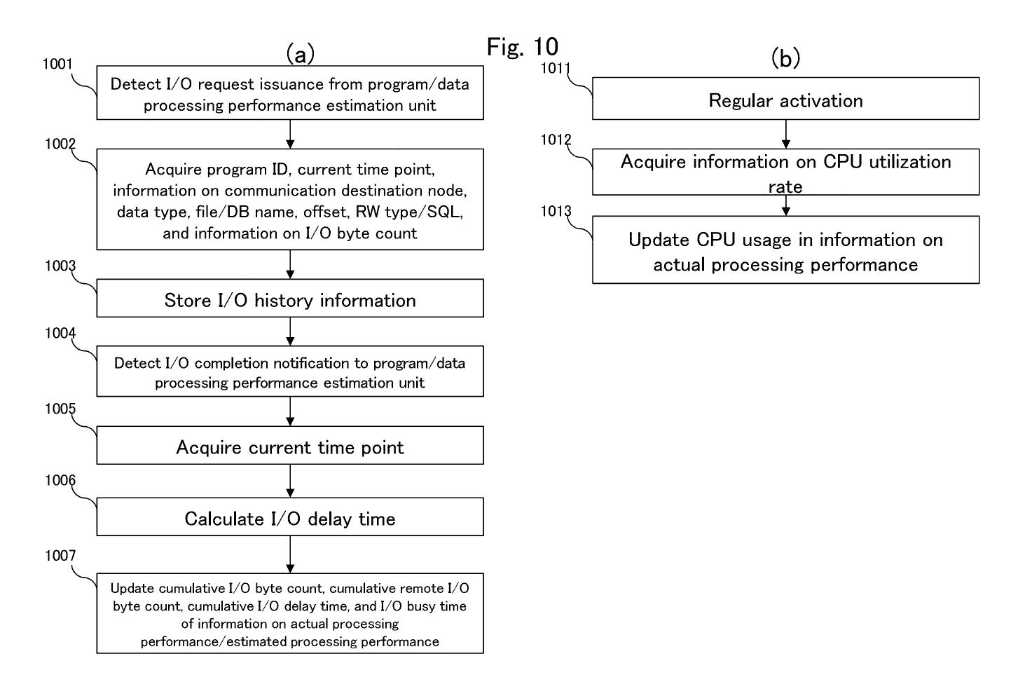

FIG. 10 shows an operation flow of the I/O history recording unit (124).

The I/O history recording unit (124) has a function for detecting data I/O events or dummy data I/O events of the program (125)/data processing performance estimation unit (123) and recording the I/O history (131), the actual processing performance (133), and the estimated processing performance (134).

The I/O history (131) has a data structure shown in FIG. 7. The I/O history (131) has fields of a “program ID” (701), an “execution time point” (702), a “communication destination node” (703), a “data type” (704), a “file/DB name” (705), an “offset” (706), an “RW type/SQL” (707), and an “I/O byte count” (708).

An ID of a program having issued a data I/O request or a dummy data I/O request is stored in the “program ID” (701). A time point of issuance of the I/O request is stored in the “execution time point” (702). An IP address of the storage node (112) storing data of a file or a DB is stored in the “communication destination node” (703). A type indicating whether data of an access destination is a file or a DB is stored in the “data type” (704). A name of a file or a name of a DB to be the access destination is stored in the “file/DB name” (705). An access destination offset in a case where the access destination is a file is stored in the “offset” (706). A type indicating either read I/O events or write I/O events in a case where the access destination is a file is stored in the “RW type/SQL” (707). An SQL is stored in a case where the access is a DB. A byte count of actually performed I/O events is stored in the “I/O byte count” (708).

As shown in FIG. 10(a), first, in step 1001, the I/O history recording unit (124) detects an I/O request issuance from the program (125)/data processing estimation unit (123).

In step 1002, information to be stored in the I/O history (131) is acquired and, in step 1003, an entry of the I/O history is created and the created I/O history entry is stored in the storage medium (113) attached to the application node (111) arranged at the headquarters site (101).

In step 1004, arrival of an I/O completion notification from the program/data processing estimation unit is detected.

In step 1005, a current time point is acquired and, in step 1006, an I/O delay time or, in other words, a difference between the current time point information acquired in step 1002 and the current time point information acquired in step 1005 is calculated.

In step 1007, the “cumulative I/O byte count” (804/903), the “cumulative remote I/O byte count” (805/904), “cumulative I/O delay time” (806/905), and “cumulative I/O busy time” (807/906) of the actual processing information (133)/estimated processing performance (132) are updated. Accordingly, performance information at the corresponding “I/O execution time point” (802/902) of the actual processing information (133) or the estimated processing performance (132) can be kept up to date.

As shown in FIG. 10(b), the “CPU utilization rate” (803) of the actual processing performance (133) is updated using regular activations as a trigger. Specifically, after performing a regular activation in step 1011, CPU utilization rate information is acquired in step 1012 and an update process of the field is performed in step 1013.

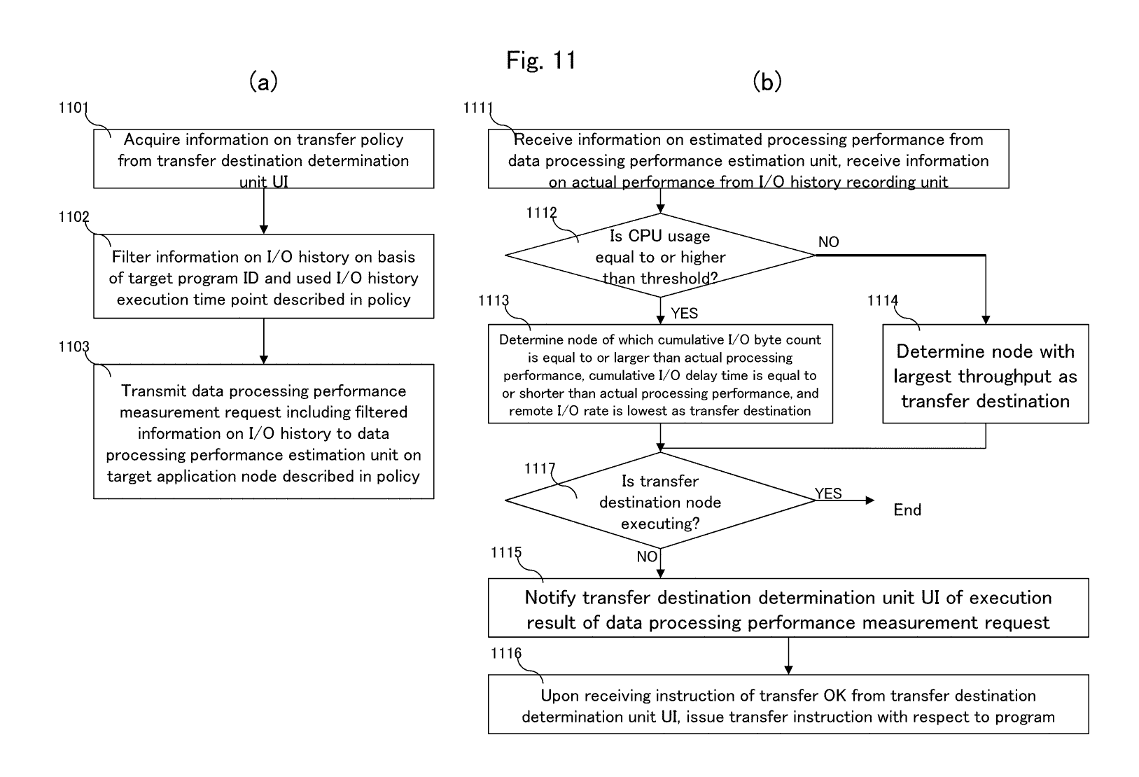

FIG. 11 shows an operation flow of the migration destination determination unit (122).

First, with an input of the transfer policy (134) to the data processing performance measurement request issuance screen (501) on the transfer destination determination unit user interface (121), the transfer destination determination unit (122) issues a data processing performance measurement request to the data processing performance estimation unit (123). As shown in FIG. 11(a), this process is performed from steps 1101 to 1103.

In step 1101, the transfer policy (134) is received from the transfer destination user interface (121).

In step 1102, the I/O history (131) corresponding to the time point described in the used I/O history execution time point (603) of the transfer policy (134) is read and acquired from the storage medium (113).

In step 1103, a data processing performance measurement request is issued with respect to the application node (111) described in the target application node (602) of the transfer policy (134). In this case, information on the I/O history acquired in step 1102 is transmitted together.

In addition, the transfer destination determination unit (122) receives the estimated processing performance (132) from the data processing performance estimation unit (123) and determines an optimal transfer destination of the program (125). This is realized in step 1111 and subsequent steps.

As shown in FIG. 11(b), in step 1111, the estimated processing performance (132) is received from the data processing performance estimation unit (123). In addition, the actual processing performance (131) is received from the I/O history recording unit (124).

In step 1112, a determination is made on whether or not an average value of the CPU utilization rate (803) of the actual processing performance (131) is equal to or larger than a value specified in the CPU utilization rate threshold (604) of the transfer policy (134). When equal to or larger than the threshold, a jump is made to step 1113, but when equal to or lower than the threshold, a jump is made to step 1114.

In step 1113, a determination is made that the computing process constitutes a CPU bottleneck since the CPU utilization rate is equal to or larger than the threshold and, on the basis of this assumption, an optimal transfer destination application node (111) is determined. Specifically, in the received estimated performance (132), estimated performance (132) of which an average value of the cumulative I/O byte count (903) of the estimated performance (132) exceeds an average value of the cumulative I/O byte count (804) of the actual processing performance (133) and of which an average value of the cumulative I/O delay time (905) of the estimated performance (132) is below an average value of the cumulative I/O delay time (806) of the actual processing performance (133) are filtered. In addition, the application node (111) at which the data processing performance estimation unit (123) having transmitted the estimated performance (132) with the smallest cumulative remote I/O byte count (805) exists under these conditions is determined as the transfer destination of the program (125). Under the conditions described above, a total amount of CPU resources used for purposes other than computing in the CPU resources of all application nodes arranged in a distributed manner can be minimized. Generally, since network I/O events consume a large amount of CPU resources, reducing a total amount of generated network I/O events results in increasing CPU utilization efficiency. An attempt is made to achieve both retention of I/O performance and CPU utilization efficiency by ensuring that current I/O performance does not decline and minimizing occurrences of I/O events via a network even when a transfer is performed.

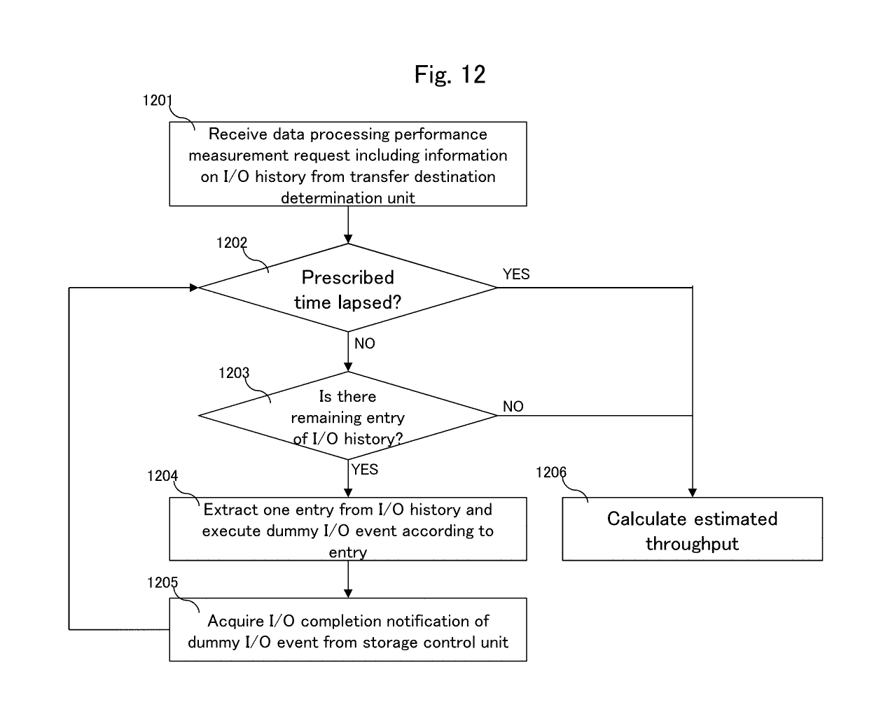

In step 1114, a determination is made that the computing process constitutes an I/O bottleneck since the CPU utilization rate is equal to or lower than the threshold and, on the basis of this assumption, an optimal transfer destination application node (111) is determined. Specifically, the application node (111) of which throughput (actual data processing throughput and estimated throughput) represents maximum performance is determined as the transfer destination of the program (125). A method of calculating the estimated throughput will be described with reference to FIG. 12. The actual data processing throughput is obtained by dividing the cumulative I/O byte count 804 by cumulative time.

After executing step 1113 or step 1114, a determination is made in step 1117 as to whether or not the selected transfer destination is an application node that currently executes the program. Subsequently, the process is ended when the selected transfer destination is an application node that currently executes the program but a jump is made to step 1115 when the selected transfer destination is not an application node that currently executes the program.

In step 1115, display contents on the data processing performance measurement result screen (502) described with reference to FIG. 5 are calculated from the received estimated processing performance (132) and handed over to the program migration destination determination unit user interface (121).

In step 1116, an input of transfer OK from the user is received via the transfer destination determination unit user interface (121) and a program transfer instruction is issued with respect to the program (125).

FIG. 12 shows an operation flow of the data processing performance estimation unit (123).

In step 1201, a data processing performance measurement request including the I/O history information (131) is received from the transfer destination determination unit (122).

In step 1202, an inspection is performed on whether or not a prescribed time (a time unit of the I/O execution time point (133) in the actual processing performance (133)) has lapsed from start of I/O reproduction. When the prescribed time has lapsed, a jump is made to step 1206 but, otherwise, a jump is made to step 1203. In step 1203, a determination is made on whether or not an I/O history entry of which I/O reproduction has not been finished exists among the entries of the received I/O history (131). When such an I/O history exists, a jump is made to step 1204 but, if not, a jump is made to step 1206.

In step 1204, one entry is extracted from the I/O history entries and, in accordance with the entry, a DB access or a file access is reproduced. When executing the reproduction, a timing of issuance of dummy data I/O events is adjusted on the basis of information on the execution time point (702) stored in the I/O history (131). Therefore, a value of an attained I/O throughput upon reproduction or, in other words, a value of the cumulative I/O byte count (903) stored in the estimated processing performance (132) only equals the cumulative I/O byte count (804) in the actual processing performance (133) at most.

In step 1205, a dummy I/O completion notification is received from the storage control unit (1204) and a return is made to step 1202. By reproducing I/O events in this manner, an I/O recording and storage unit becomes capable of configuring values of the respective fields of the cumulative I/O byte count (903), the cumulative remote I/O byte count (904), the cumulative I/O delay time (905), and the cumulative I/O busy time (906) of the estimated processing performance to measured values.

In step 1206, on the basis of measured values of the cumulative I/O byte count (903), the cumulative remote I/O byte count (904), the cumulative I/O delay time (905), and the cumulative I/O busy time (906) of the estimated processing performance (132), the estimated throughput (907) or, in other words, a data processing throughput that can be attained when transferring the program (125) to the application node (111) is calculated.

This calculation is performed using, for example, the following algorithm. First, the cumulative I/O byte count (903) described in the estimated processing performance (132) and the cumulative I/O byte count (804) described in the actual processing performance (133) are compared with each other. The former being lower than the latter means that reproduction of I/O events by the data processing performance estimation unit (123) requires more time than data I/O execution by the program (125). Therefore, it is assumed that the data processing throughput after transfer is equal to throughput of dummy data I/O events attained upon reproduction of I/O events or, in other words, the estimated throughput (907) is equal to the current cumulative I/O byte count (903). On the other hand, the former being higher than the latter means that there is I/O processing capability to spare even when the reproduction of I/O events is performed by the data processing performance estimation unit. In consideration thereof, an I/O busy rate that is a cumulative I/O busy time per minute is calculated from the cumulative I/O busy time (906), and a value obtained by multiplying the cumulative I/O byte count (903) by a reciprocal of the calculated I/O busy rate is adopted as the estimated throughput (907). For example, the estimated throughput at an I/O history execution time point of 11:22 is obtained as 12345*60/40=18517 (Byte/s).

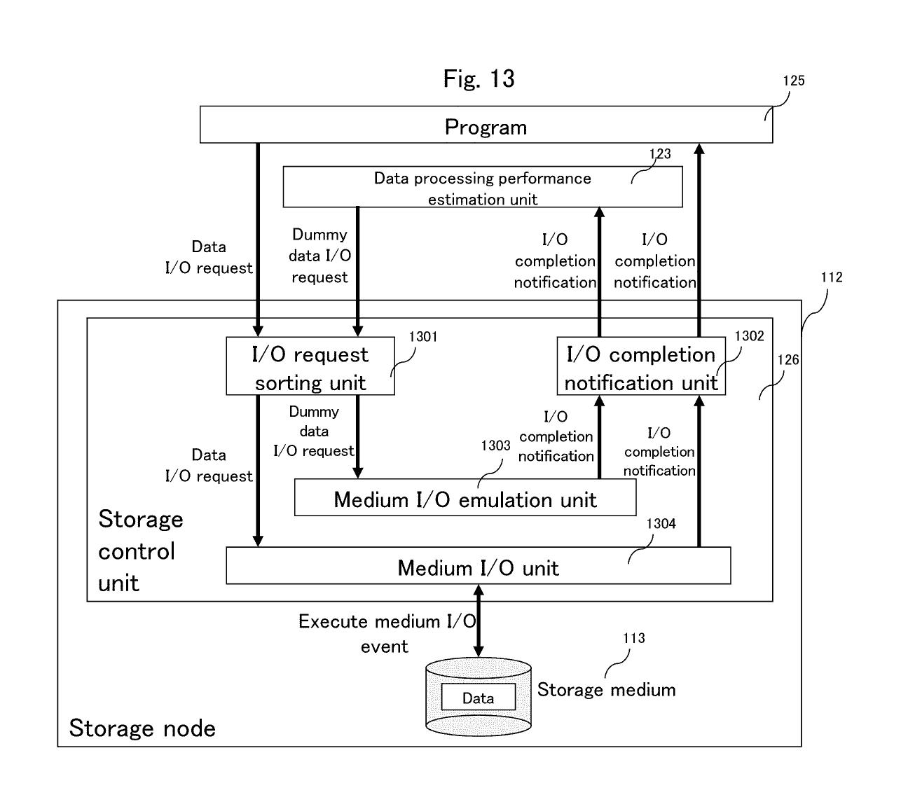

FIG. 13 shows a summary of operations of the storage control unit (126).

The storage control unit (126) processes not only data I/O events issued by the program (125) but also processes dummy data I/O events issued by the data processing estimation unit (123). While I/O events with respect to the storage medium (113) of the storage node (112) are executed in data I/O processing, in dummy data I/O processing, a lapse of I/O processing time is emulated without performing the I/O events. According to the present function, generation of a load on the storage medium (113) during a measurement of estimated processing performance by the data processing performance estimation unit (123) can be suppressed.

In order to realize the above, the storage control unit includes an I/O request sorting unit (1301) and determines whether an arrived I/O request is a data I/O request or a dummy data I/O request. In the case of a data I/O request, the request is transferred to a medium I/O unit and medium I/O events with respect to the storage medium (113) are made effective. In the case of a dummy data I/O request, the request is transferred to a medium I/O emulation unit (1303) and a lapse of a time point equivalent to storage medium I/O events is awaited. A known method is used as an awaiting method by the emulation unit. For example, actual I/O events are executed in advance in various I/O sizes and with random read/write patterns and sequential read/write patterns, and processing times thereof are measured. In addition, when dummy I/O events actually arrive, an I/O pattern and a size thereof are measured to enable an awaiting time to be determined from the measured processing times. In either case, upon completion of processing, the program (125) or the data processing performance estimation unit (123) is notified of an I/O completion notification through the I/O completion notification unit (1302).

### Second Embodiment

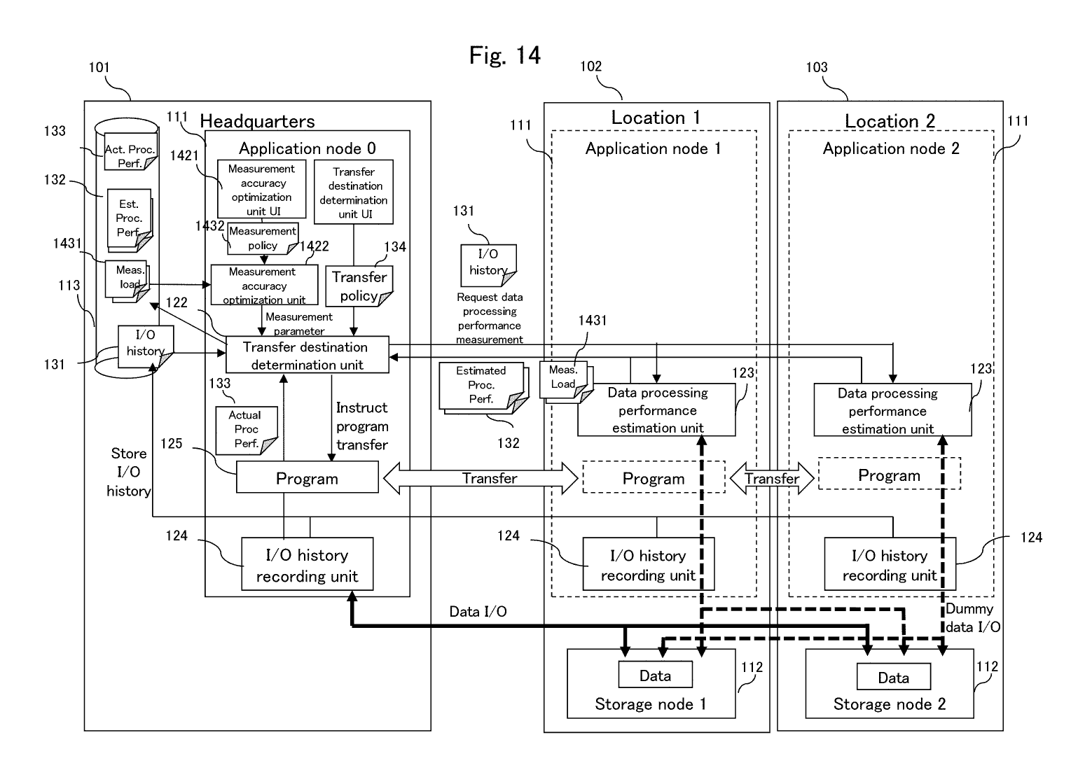

FIG. 14 shows a software module configuration of a second embodiment of the present invention.

The present embodiment causes a measurement load (1431) to be transmitted from the data processing performance estimation unit (123) to the transfer destination determination unit (122) in addition to the configuration of the first embodiment. In addition, the transfer destination determination unit (122) stores information on the actual processing performance (133), the estimated processing performance (132), and the measurement load (1431) in the storage medium (113) directly coupled to the application node (111) arranged at the headquarters site (101).

A measurement accuracy optimization unit (1422) receives a measurement policy (1432) from a measurement accuracy optimization unit user interface (1421). On the basis of the measurement policy (1432), the actual processing performance (133), the estimated processing performance (132), and the measurement load (1431), the measurement accuracy optimization unit (1422) determines an optimal measurement parameter (an amount of time of I/O history to be used as measurement target, a measurement interval) and notifies the program transfer destination determination unit (122) of the determined measurement parameter. The program transfer destination determination unit periodically issues a data processing performance measurement request to the data processing performance estimation unit on the basis of the measurement parameter. As a result, in the present embodiment, a transfer destination of the program can be automatically determined without having to instruct execution of a data processing performance measurement request via the transfer destination determination unit user interface (121).

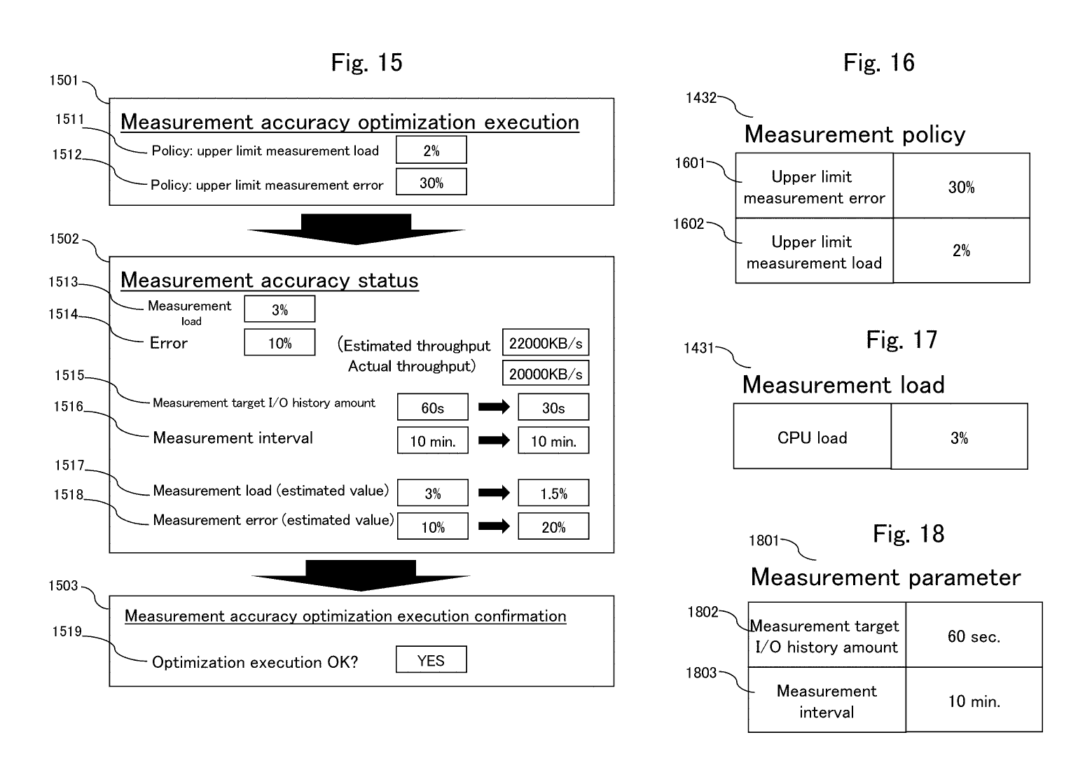

FIG. 15 shows a user interface screen provided by the measurement accuracy optimization unit user interface (1421).

The present user interface screen is constituted by a measurement accuracy optimization execution instruction screen (1501), a measurement accuracy status display screen (1502), and a measurement accuracy optimization execution confirmation screen (1503).

The measurement policy (1432) is input on the measurement accuracy optimization execution instruction screen (1501).

The measurement policy (1432) includes an upper limit measurement load 1511 and an upper limit measurement error 1512, both of which are to be input by the user.

As shown in FIG. 16, the measurement policy (1432) has fields of an upper limit measurement error (1601) and an upper limit measurement load (1602) of which a parameter is to be input on the present screen.

The measurement accuracy status display screen (1502) displays a status of current measurement accuracy and a degree of change in the accuracy as a result of measurement parameter adjustment.

First, fields of a measurement load (1513) and an error (1514) exist on the present screen. The measurement load (1513) displays information on the measurement load (1431) obtained by a return from the data processing performance estimation unit (123). As shown in FIG. 17, the measurement load (1431) obtained by a return from the data processing performance estimation unit (123) has a CPU load field and stores information on CPU loads required by the respective data processing performance estimation units (123) to issue a dummy I/O request. The measurement accuracy optimization unit (1422) calculates an average value thereof, hands over the calculated average value to the measurement accuracy optimization unit user interface (1421), and causes the average value to be displayed in the measurement load (1513) field. Meanwhile, the error (1514) displays an error of the estimated processing performance (132) estimated by each data processing performance estimation unit (123) and the actual processing performance (131) attained as a result of program transfer. For example, an actual data processing throughput is obtained by dividing the cumulative I/O byte count 804 by time, and an error between the estimated throughput 907 and the actual measured throughput is obtained. The measurement accuracy optimization unit (1422) calculates average values of an estimated data processing throughput, an actual data processing throughput, and an error from the information described above stored in the storage medium (113). Subsequently, the average values are handed over to the measurement accuracy optimization unit user interface (1421) and the average values are caused to be displayed in the error (1514) field.

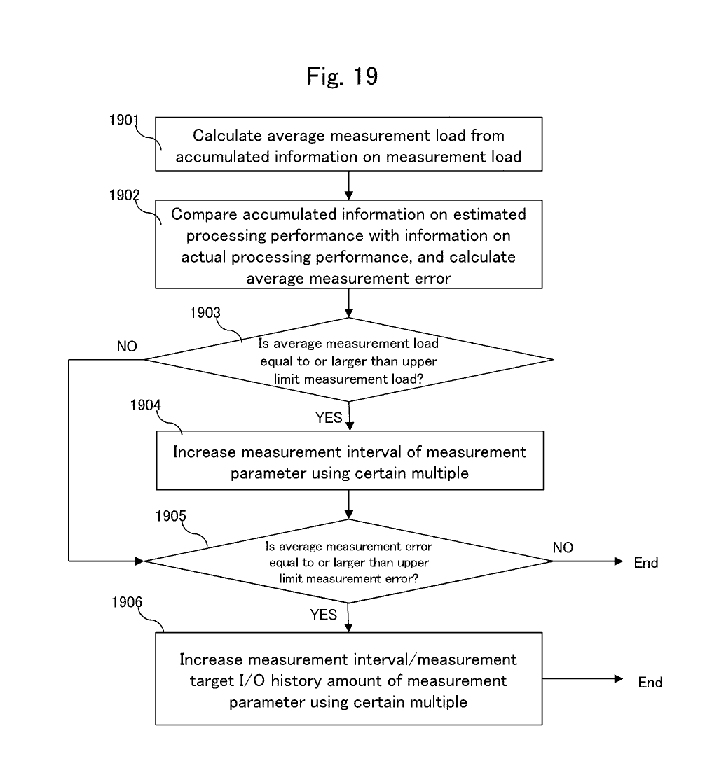

Measurement parameter information is displayed in fields of a measurement target I/O history amount (1515) and a measurement interval (1516). As shown in FIG. 18, the measurement parameter stores fields for storing these pieces of information. A current value of the parameter and a change content proposal thereof are displayed in the present field. A method of calculating the change content proposal executed by the measurement accuracy optimization unit (1422) will be described with reference to FIG. 19.

Fields of a measurement load (estimated value) (1517) and a measurement error (estimated value) (1518) display estimates regarding how these values may change due to the measurement parameter change described above. A method of calculating the present estimated values executed by the measurement accuracy optimization unit (1422) will also be described with reference to FIG. 19.

The measurement accuracy optimization execution confirmation screen (1503) is a screen for performing user confirmation on whether a change to the measurement parameter is to be performed. When a change confirmation is obtained as a result of the user pressing a YES operation button or the like on the present screen, the measurement accuracy optimization unit (1422) notifies the transfer destination determination unit (122) of a new measurement parameter.

FIG. 19 shows an operation flow of the measurement accuracy optimization unit (1422).

First, in step 1901, an average measurement load is calculated from the measurement load (1431) accumulated in the storage medium (113).

Next, in step 1902, an average measurement error is calculated from the estimated processing performance (132) and the actual processing performance (133) accumulated in the storage medium (113).

In step 1903, a determination is made on whether or not the average measurement load calculated in step 1901 is equal to or larger than an upper limit value specified in the field of the upper limit measurement load (1602) of the measurement policy (1432). When equal to or larger than the upper limit, a jump is made to step 1904, but when smaller than the upper limit, a jump is made to step 1905.

In step 1904, an adjustment of the measurement interval of the measurement parameter (1801) is performed. On the assumption that the measurement interval and the measurement load are in an inversely proportional relationship, a new value of the measurement interval (1802) capable of attaining a target upper limit measurement load (1602) is calculated.

In step 1905, a determination is made on whether or not the average measurement error calculated in step 1902 is equal to or larger than an upper limit value specified in the field of the upper limit measurement error (1601) of the measurement policy (1432). When equal to or larger than the upper limit, a jump is made to step 1906, but when smaller than the upper limit, the process is ended.

In step 1906, an adjustment of the measurement target I/O history amount (1802) of the measurement parameter (1801) is performed. On the assumption that the measurement target I/O history amount and the measurement error are in an inversely proportional relationship, a new value of the measurement target I/O history amount (1802) capable of attaining a target upper limit measurement error (1601) is calculated. However, on the assumption that the measurement load also increases in proportion to the measurement target I/O history amount (1802), the measurement interval (1803) is similarly increased so as not to change the measurement load.

Through these steps, a value of a new measurement parameter (1801) and estimated values of the measurement error and the measurement load can be calculated. These values are handed over to the measurement accuracy optimization unit user interface (1421) and the values are caused to be displayed on the measurement accuracy status display screen (1502).

### REFERENCE SIGNS LIST

111 Application node
112 Storage node
121 Transfer destination determination unit UI
122 Transfer destination determination unit
123 Data processing performance estimation unit
124 I/O history recording unit
125 Program
131 I/O history
132 Estimated processing performance
133 Actual processing performance
134 Transfer policy

1. A data processing system in which application nodes capable of executing a program are provided at sites at a plurality of locations and storage nodes storing data are also provided at the plurality of locations, the locations being coupled to one another via a network, wherein
a first application node that is an application node among the plurality of application nodes is configured to:
record a history of I/O events issued to a storage node by executing the program; and
measure actual data processing performance during execution of the program;
a second application node among the plurality of application nodes is configured to:
receive a history reproduction request of I/O events including the history of I/O events; and
issue reproduction I/O events for reproducing the I/O events issued by the program in accordance with the history of I/O events included in the history reproduction request of I/O events and obtain performance of the reproduction I/O events as estimated performance of I/O events, and
the first application node is configured to:
transfer the program to the second application node when determine is made that, on the basis of the estimated performance of I/O events obtained by the second application node, the program is to be transferred to the second application node.

2. The data processing system according to claim 1, wherein
the storage node is configured to sort out I/O events issued by executing the program and the reproduction I/O events and, in a case of I/O events issued by the program, execute I/O events with respect to a recording medium at the storage node, but in a case of the reproduction I/O events,
await time corresponding to the I/O events with respect to the recording medium.

3. The data processing system according to claim 2, wherein
when CPU usage of the first application node is lower than a threshold,
the program is transferred to the second application node when an estimated throughput of the second application node is larger than an actual data processing throughput of the first application node.

4. The data processing system according to claim 2, wherein
when CPU usage of the first application node is equal to or higher than a threshold,
whether or not to transfer the program to the second application node is determined from actual data processing performance of the first application node and the estimated I/O performance.

5. The data processing system according to claim 1, wherein the first application node is configured to:
accept an upper limit value of a measurement load required to execute the I/O history reproduction and an upper limit value of an estimated error of the estimated I/O performance and, on the basis of the upper limit values, adjust an issuance interval of the I/O history reproduction request and an amount of I/O history to be included in the I/O history reproduction request.

6. A data processing method in which application nodes capable of executing a program are provided at sites at a plurality of locations and storage nodes storing data are also provided at the plurality of locations, the locations being coupled to one another via a network,
the data processing method comprising:
recording a history of I/O events issued to a storage node by executing the program at a first application node that is an application node among the plurality of application nodes;
measuring actual data processing performance during execution of the program;
making a history reproduction request of I/O events, which include the history of I/O events, to a second application node among the plurality the application nodes;
issuing reproduction I/O events for reproducing the I/O events issued by the program in accordance with the history of I/O events included in the history reproduction request of I/O events and obtaining performance of the reproduction I/O events as estimated performance of I/O events, by the second application node; and
determining, on the basis of the estimated performance of I/O events obtained by the second application node, whether or not to transfer the program to the second application node.

7. The data processing method according to claim 6, wherein
the storage node sorts out I/O events issued by executing the program and the reproduction I/O events and, in a case of I/O events issued by the program, executes I/O events with respect to a recording medium at the storage node, but in a case of the reproduction I/O events,
awaits time corresponding to the I/O events with respect to the recording medium.

8. The data processing method according to claim 7, wherein
when CPU usage of the first application node is lower than a threshold,
the program is transferred to the second application node when an estimated throughput of the second application node is larger than an actual data processing throughput of the first application node.

9. The data processing method according to claim 7, wherein
when CPU usage of the first application node is equal to or higher than a threshold,
whether or not to transfer the program to the second application node is determined from actual data processing performance of the first application node and the estimated I/O performance.

10. The data processing method according to claim 6, wherein the first application node
accepts an upper limit value of a measurement load required to execute the I/O history reproduction and an upper limit value of an estimated error of the estimated I/O performance and, on the basis of the upper limit values, adjusts an issuance interval of the I/O history reproduction request and an amount of I/O history to be included in the I/O history reproduction request.
